(19) United States
(12) Patent Application Publication
(10) Pub. No.: US 2009/0184600 A1
(43) Pub. Date: Jul. 23, 2009

(54) CONDUCTOR BAR FOR A ROTATING ELECTRICAL MACHINE

(75) Inventor: Thomas Baumann, Wettingen (CH)

Correspondence Address: DARBY & DARBY P.C., P.O. BOX 770, Church Street Station, New York, NY, 10008-0770, US

(73) Assignee: ALSTOM Technology Ltd., Baden (CH)

(21) Appl. No.: 12/356,995

(22) Filed: Jan. 21, 2009

(30) Foreign Application Priority Data
Jan. 17, 2008 (DE) 102008000073.6

(51) Int. Cl. H02K 3/40; H02K 3/34

(52) U.S. Cl. 310/196; 310/215

(57) ABSTRACT

A conductor bar for a rotating electrical machine has an inner conductor with an essentially rectangular cross section sheathed in a straight section of the conductor bar by mica tape insulation.

Priority is claimed to German Patent No. DE 10 2008 000 073.6, filed on Jan. 17, 2008, the entire disclosure of which is incorporated by reference herein.

The present invention relates generally to the field of rotating electrical machines, and in particular to a conductor bar for a rotating electrical machine.

### BACKGROUND

In large rotating electrical machines, windings which are composed of individual conductor bars are used in the area of the stator and/or rotor. The conductor bars, which normally have a rectangular cross section, are inserted with a straight part into corresponding axial slots in the stator body or rotor body, and are connected to one another in an end winding at the ends which project out of the body (EP-A2-1 653 588). By way of example, the conductor bars are designed as illustrated in FIG. 1: the conductor bar 10 has an electrically conductive inner conductor 11 composed of copper, which generally comprises a multiplicity of conductor elements 12. The inner conductor 11 is surrounded by insulation 14 whose first and innermost section is in the form of mica insulation 13, in order to avoid discharges. The longitudinal edges 25 of the inner conductor play a major role in the breakdown resistance, and are characterized by an edge radius rᵢ.

The glass/mica insulation 13 as shown in FIG. 2 is wound in the form of mica tapes 15 in a plurality of layers in a spiral onto the inner conductor 11 with an overlap OL of about 50% (by hand or by machine). The maximum tape width (B in FIG. 6) is governed by the sharpest edge radius. Tape widths of 15 to 30 mm are normally used.

Investigations on conductor bars which have broken down in long-term electrical tests show, in the majority of cases, that
1. the breakdown occurs in the slot part (that is to say the straight part of the generator bar);
2. the breakdown occurs on the longitudinal edge (25 in FIG. 1);
3. the breakdown occurs in the first mica tape layer (that is to say directly on the inner conductor 11) on the edge of the tape (16 in FIG. 3).

Re point 2:the occurrence on the longitudinal edge 25 can be understood because this is where there is a considerable peak in the field strength; the field strength precisely above the copper is approximately:

$${E}_{max} = \frac{U}{\sqrt{3 \cdot } {r}_{i} \cdot ln [ ( d + {r}_{i} ) / {r}_{i} ]} .$$

In this case, U is the applied voltage, rᵢ is the radius of the inner conductor 11 and the thickness of the overall insulation 14. The “natural” edge radius is given by the radius of the conductor elements 12 from which the inner conductor 11 is formed (this radius is normally 0.5 mm).

The field peak effect can be ameliorated by rounding (for example by grinding) the inner conductor 11. However, it is virtually impossible to achieve more than rᵢ=2.5 mm since greater rounding cannot be achieved without grinding onto the conductor elements 12 (and thus constricting the current path).

Re Point 3: The edge 16 of the first mica tape layer 15 represents a dielectric discontinuity (see the areas surrounded by dashed lines in FIG. 3). This edge area is either filled with pure resin (with a different permeability to that of the mica tape 15) or is not filled at all (that is to say it is a cavity). As shown in FIG. 4, two mica tapes 17 and 18 are normally wound with a ¼ tape width offset and a half overlap OL, thus resulting in a discontinuity such as this every 6.25 mm, in the case of a tape width of 25 mm.

### SUMMARY OF THE INVENTION

An aspect of the invention is to provide a conductor bar in which the breakdown probability at the edge is reduced.

At least one first mica tape is wound around the inner conductor and adjacent parallel edges of the first mica tape, which is wound around the inner conductor, have an overlap which is substantially less than half the width of the first mica tape. The dielectric discontinuity at the edge of the conductor bar or of the inner conductor is reduced or overcome in that tape edges occur considerably less often in the first (or first and second) mica tape layer than in known conductor bars.

One refinement of the invention is characterized in that the first mica tape is wound in a helical shape around the longitudinal axis of the conductor bar. The width of the first mica tape is in this case preferably greater than 50 mm and, in particular, is about 100 mm.

Another refinement of the invention is distinguished in that the first mica tape is wound around the conductor bar with its longitudinal axis parallel to the longitudinal axis of the conductor bar. In this case, preferably, the first mica tape is wound with its longitudinal axis around the conductor bar such that the edges of the first mica tape lie in the side surfaces of the conductor bar.

In this case, it is particularly advantageous if the width of the first mica tape is essentially the same as the external circumference of the inner conductor, as a result of which the parallel edges of the first mica tape form a butt joint running in the longitudinal direction.

A further refinement of the invention is characterized in that the first mica tape is wound with a minute overlap such that the adjacent parallel edges of the first mica tape form a butt joint.

In addition, the first mica tape on the lower face can be designed to be electrically poorly conductive. In particular, this could be achieved in that the first mica tape has a mica layer which is coated with graphite or carbon black on the lower face.

However, it is also feasible that the first mica tape has a mica layer which is applied to an electrically conductive web layer, wherein the electrically conductive web layer may comprise, in particular, a carbon-fiber web or an electrically conductive polyester non-woven.

In addition, a glass-fiber web can be applied to the mica layer.

If the first mica tape is applied with the longitudinal axis parallel to the longitudinal axis of the conductor bar, it is advantageous for it to be fixed on the inner conductor by an adhesive substance. In this case, the adhesive substance is, in particular, an impregnation resin or a silicone elastomer.

### BRIEF DESCRIPTION OF THE DRAWINGS

The invention will be explained in more detail in the following text with reference to exemplary embodiments and in conjunction with the drawings, in which:

FIG. 1 shows the section through a conductor bar such as that on which the invention is based;

FIG. 2 shows a conventional winding layout for the first mica tape with a half-width overlap;

FIG. 3 shows the problem zones with the highly overlapping winding;

FIG. 4 shows the problem zones with simultaneously winding with two offset tapes;

FIG. 5 shows helical winding with the first mica tape with a small overlap, according to one exemplary embodiment of the invention;

FIG. 6 shows helical winding without any overlap, and with a butt joint, according to another exemplary embodiment of the invention;

FIG. 7 shows the winding with a butt joint, with the longitudinal direction of the tape parallel to the longitudinal direction of the conductor bar, according to a further exemplary embodiment of the invention;

FIG. 8 shows a possible two-layer structure of the mica tape used for the invention; and

FIG. 9 shows a possible three-layer structure for the mica tape used according to the invention.

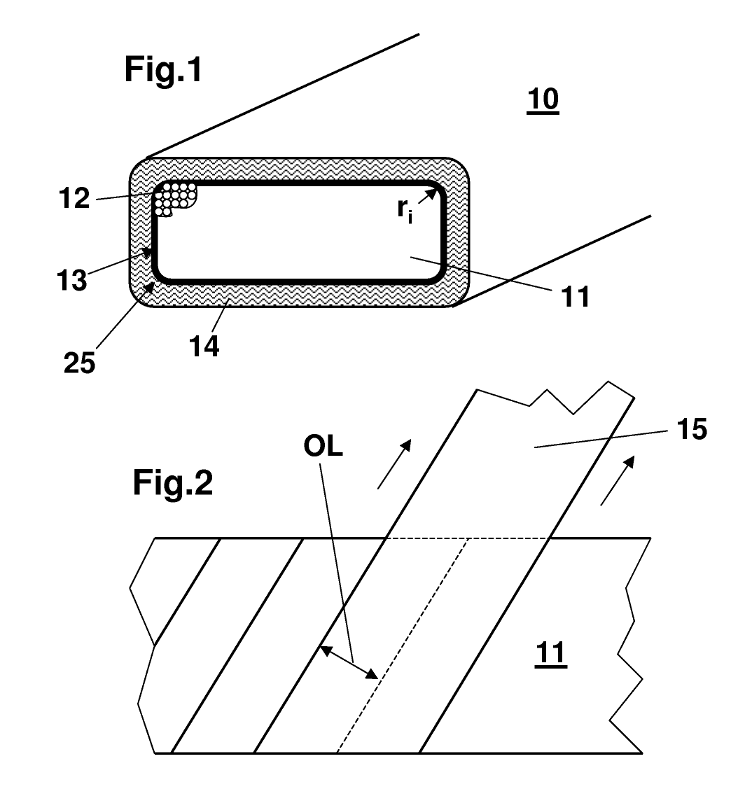

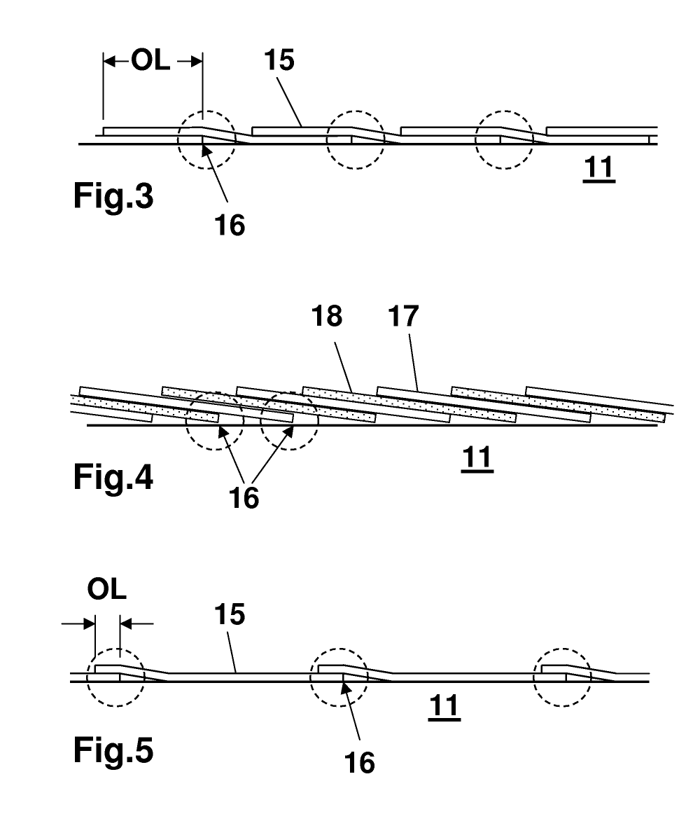

### DETAILED DESCRIPTION

In the first exemplary embodiment of the invention, a decrease is achieved in the breakdown probability on the longitudinal edge 25 of the inner conductor 11 by winding a mica tape of normal width in only one layer, with an overlap OL which is reduced in comparison to the conventional winding technique (FIG. 5). This considerably reduces the frequency of the edges 16 per unit length of the conductor bar in the longitudinal direction.

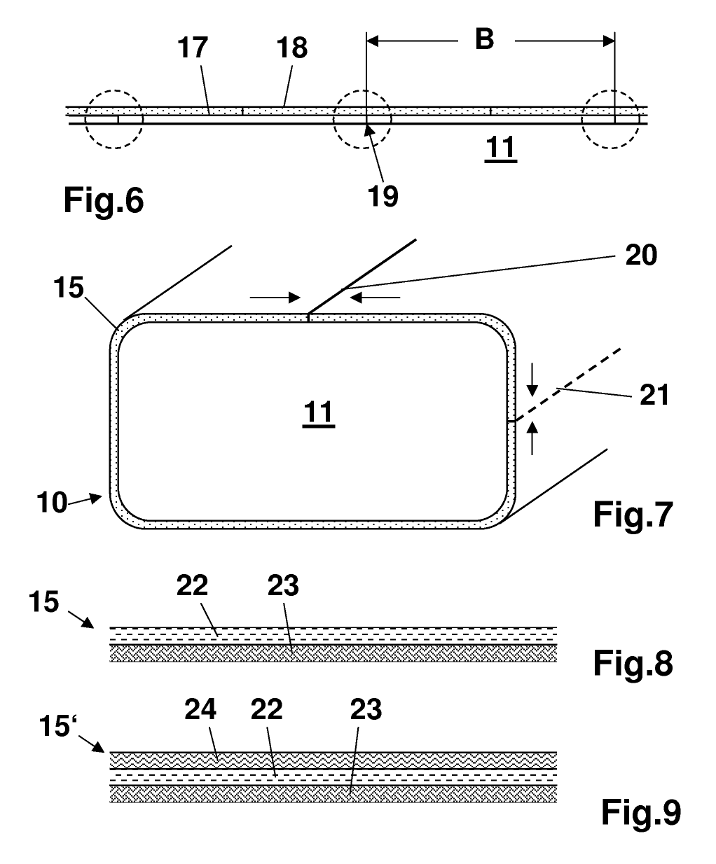

In the overlap limiting case of 0 (FIG. 6), that is to say with the winding forming a butt joint 19, the frequency of the edge is reduced by a factor of 4 in comparison to the prior art. In this preferred embodiment of the butt-jointed winding, the butt joint 19 in the first mica tape 17 is covered by a second, likewise butt-jointed, layer of a mica tape 18. This type of winding should be restricted to the straight part of the conductor bar 10 (which is located in the winding slot) since it is not possible to wind with a butt joint in the curved area of the bar. In one particularly preferred embodiment, a tape with a considerably greater width B, in particular of more than 50 mm, for example 100 mm, should be used for this purpose.

A second embodiment, by means of which it is possible to completely avoid any tape edges on the bar edge 25, comprises the application as a first layer of a web of the length of the straight part and of the width of the copper bar circumference or inner-conductor circumference in the form of a butt joint (FIG. 7). The butt joint 20, 21 of the mica tape 15 then runs in the axial direction of the conductor bar 10 in the area of the center of the narrow face or broad face of the bar, that is to say well away from the bar edge. In order to ensure that this mica tape remains on the bar, it must be adhesively bonded on, for example by impregnation resin or a silicone elastomer. In the latter case, an additional advantage is that the connection between the inner conductor 11 and the insulating sleeve (main insulation 14) is elastic. This allows shear stresses, produced by the difference in the thermal coefficients of expansion between copper and the main insulation 14, to be converted to strain without this leading to tearing of the adhesive joint.

A mica tape such as this can in one preferred embodiment be formed such that it is poorly conductive on its lower face. This can be achieved by means of a graphite or carbon-black coating. However, it is also feasible (FIG. 8) for the mica (mica layer 22) to be coated onto an electrically conductive web layer 23, in particular a carbon-fiber web or a conductive polyester non-woven. The mica tape 15 is then a two-layer material (for example C-fiber web/mica).

The mica tape 15′ can, as shown in FIG. 9, also, however, be a three-layer material (for example C-fiber web/mica/glass-fiber web), in which a glass-fiber web 24 is also applied over the mica layer 22. The conductive layer 23 is than used as complete internal corona-discharge protection, which is in close and permanent contact with the main insulation 14.

### LIST OF REFERENCE SYMBOLS

10 Conductor bar
11 Inner conductor
12 Conductor element
13 Mica insulation
14 Main insulation
15, 15′ Mica tape
16 Edge
17, 18 Mica tape
19 Butt joint
20,21 Butt joint
22 Mica layer
23 Web layer (electrically conductive)
24 Glass-fiber web
25 Longitudinal edge
B Width (mica tape)
OL Overlap

What is claimed is:

1. A conductor bar for a rotating electrical machine, the conductor bar comprising:
an inner conductor having an essentially rectangular cross section; and
a mica tape insulation sheathing the inner conductor in a straight section of the conductor bar, wherein the mica tape insulation includes at least one first mica tape having a width and wound around the inner conductor so that adjacent parallel edges of the first mica tape form an overlap, and wherein the overlap is substantially less than half the width.

2. The conductor bar as recited in claim 1, wherein the first mica tape is wound in a helical shape with respect to a longitudinal axis of the straight section.

3. The conductor bar as recited in claim 1, wherein the width is greater than 50 mm.

4. The conductor bar as recited in claim 3, wherein the width is about 100 mm.

5. The conductor bar as recited in claim 1, wherein the first mica tape is wound around the conductor bar and has a tape longitudinal axis parallel to a bar longitudinal axis of the conductor bar.

6. The conductor bar as recited in claim 5, wherein the first mica tape is wound with its longitudinal axis around the conductor bar such that the edges lie in side surfaces of the conductor bar.

7. The conductor bar as recited in claim 5, wherein the width of the first mica tape is essentially the same as an external circumference of the inner conductor such that the parallel edges of the first mica tape form a butt joint.

8. The conductor bar as recited in claim 1, wherein the first mica tape is wound with a minute overlap such that the adjacent parallel edges of the first mica tape form a butt joint.

9. The conductor bar as recited in claim 1, wherein the first mica tape is electrically poorly conductive.

10. The conductor bar as recited in claim 9, wherein the first mica tape has a mica layer coated on a lower face with one of graphite and carbon black.

11. The conductor bar as recited in claim 9, wherein the first mica tape has a mica layer applied to an electrically conductive web layer.

12. The conductor bar as recited in claim 11, wherein the electrically conductive web layer includes one of a carbon-fiber web and an electrically conductive polyester non-woven.

13. The conductor bar as recited in claim 11, wherein the first mica tape includes a glass-fiber web applied to the mica layer.

14. The conductor bar as recited in claim 5, further comprising an adhesive substance fixing the first mica tape on the inner conductor.

15. The conductor bar as recited in claim 14, wherein the adhesive substance includes one of an impregnation resin and a silicone elastomer.
